(19) United States
(12) Patent Application Publication
(10) Pub. No.: US 2010/0289973 A1
(43) Pub. Date: Nov. 18, 2010

(54) MULTIFUNCTIONAL THERAPEUTIC DEVICE WITH EDUCATIONAL AND ENTERTAINMENT FUNCTIONS

(75) Inventors: Chang-ho JUNG, Busan-si (KR); Kwang-cheol Park, Busan-si (KR); Jong-moon Na, Busan-si (KR); Tae-doo Jung, Busan-si (KR)

Correspondence Address: Hyun Jong Park;Park & Associates Intellectual Property Law LLC, Suite 106, 265 Bic Drive, Milford, CT, 06461, US

(73) Assignee: SAMCHANG S.C CO., LTD., Busan (KR)

(21) Appl. No.: 12/776,597

(22) Filed: May 10, 2010

(30) Foreign Application Priority Data
May 12, 2009 (KR) 10-2009-0041040

(51) Int. Cl. H04N 5/57; H04N 5/64; H04R 1/02

(52) U.S. Cl. 348/836; 348/687; 381/388; 348/E05.128; 348/E05.119

(57) ABSTRACT

Disclosed herein is a multifunctional therapeutic device with educational and entertainment functions, including a body including a program engine and a power supply unit. The multifunctional therapeutic device includes a data storage unit, an image display unit, and a sound output unit. The data storage unit is removably mounted on the body, is electrically connected to the program engine, and temporarily stores image and sound output data. The image display unit is mounted on the remaining side of the body so that its angle can be adjusted, is electrically connected to the program engine, and outputs an image through the program engine. The sound output unit is mounted between the data storage unit and the image display unit, is electrically connected to the program engine, and outputs a sound through the program engine. The image display unit and the sound output unit are operated separately or in combination.

### FIELD OF THE INVENTION

The present invention relates generally to a multifunctional therapeutic device with educational and entertainment functions, and, more particularly, to a multifunctional therapeutic device with educational and entertainment functions, which has a structure in which a sound output unit is disposed between a data storage unit and an image display unit which are respectively provided on both sides of a body, so that the multifunctional therapeutic device can promote consumers' desire to possess it, improve educational performance and cultivate feelings by stimulating interest, and provide psychological therapy by putting the body and mind at ease.

### BACKGROUND OF THE INVENTION

People today are experiencing a lot of discomfort due to psychological stress, and are using a variety of types of therapeutic devices in order to relieve such stress. Focusing on this point, the inventor of the present invention obtained Korean Utility Model Registration No. 20-0422164 entitled “Multifunctional Lamp.”

FIGS. 5 to 7 show the overall configuration of the conventional technology. From these drawings, it can be seen that the conventional technology includes a body 10 provided with a speaker 32 and a color selection switch 12, a light source unit 20 installed on the body 10, a sound source unit 30 installed in the body 10, a control unit 40 installed in the body 10, and a cover 50 combined with the body 10.

Here, the body 10 is further provided with a perfume generation chip 60 which selectively emits perfume under the control of the control unit 40, and wheels 70 which are used to move the device are provided underneath the body 10.

However, the conventional technology has a problem in that the conventional technology does not satisfy the educational, clinical and entertainment purposes of a variety of different age groups due to its being limited in purpose because the conventional technology falls within the range of illumination devices which simply emit light.

### SUMMARY OF THE INVENTION

Accordingly, the present invention has been made keeping in mind the above problems occurring in the prior art, and an object of the present invention is to provide a multifunctional therapeutic device with educational and entertainment functions, which is capable of promoting consumers' desire to possess it, improving educational performance and cultivating feelings by stimulating interest, and providing psychological therapy by putting the body and mind at ease.

In order to accomplish the above object, the present invention provides a multifunctional therapeutic device with educational and entertainment functions, including a body including a program engine for outputting an image and a sound and a power supply unit for supplying driving power, the multifunctional therapeutic device including a data storage unit removably mounted on one side of the body, electrically connected to the program engine, and configured to temporarily store image and sound output data downloaded from an outside; an image display unit mounted on a remaining side of the body so that an angle thereof can be adjusted in all directions, electrically connected to the program engine, and configured to output an image through the program engine based on image output data of the data storage unit; and a sound output unit mounted between the data storage unit and the image display unit, electrically connected to the program engine, and configured to output a sound through the program engine based on sound output data of the data storage unit; wherein the image display unit and the sound output unit are operated separately or in combination.

The multifunctional therapeutic device may further include, on both sides of the body between the data storage unit and the image display unit, an adjustment and selection unit electrically connected to the program engine, and configured to adjust brightness of the image output from the image display unit and pitch of a sound output from the sound output unit and to select a type of program engine of the body including the power supply unit.

The adjustment and selection unit may include an adjustment switch rotatably mounted on one side of the body between the data storage unit and the image display unit, and configured to adjust brightness of the image output from the image display unit and the pitch of the sound output from the sound output unit; and a selection switch rotatably mounted on a remaining side of the body between the data storage unit and the image display unit, and configured to select the type of program engine of the body including the power supply unit or selectively turn on and off power.

The body may further include a head part rotatably attached to the body including the power supply unit; the image display unit may be mounted on one end of the head part; and the adjustment and selection unit may be mounted on both sides of the head part.

The head part may further include a spherical joint provided on one end of a neck protruding downwards and rotatably combined with the body.

The data storage unit may include a fastening element electrically connected to an external device or the program engine of the body, and a storage body electrically connected to the fastening element and configured to temporality store downloaded image and sound output data.

The fastening element may be connected to the body or external device using a USB method, an RFID method, an infrared wireless communication method or an S-ATA method.

The storage body may be formed of any one of USB memory, flash memory and a hard disk.

The image display unit may include a display panel for outputting an image, and an image encoder for electrically connecting the display panel and the program engine to each other and converting driving information of the program engine into an image signal.

The display panel may be formed of any one of RGB LEDs, an LCD and a PDP.

The sound output unit may include a speaker mounted on the body including the power supply unit and configured to output a sound, and a sound encoder for electrically connecting the speaker and the program engine to each other, and configured to convert driving information of the program engine into a sound signal.

The body may further include a plurality of support legs mounted on an outside of the body, configured to support the body, and electrically connected to the power supply unit, and the speaker may be mounted on the bottom of the body.

The support legs may be provided with electrodes provided at ends of the support legs and electrically connected to the power supply unit of the body on which the speaker is mounted.

The body may further include a charging dock, including a support body provided with support depressions in which the support legs are placed and disposed to face the speaker, charging electrodes disposed in the support depressions and configured to come into contact with the electrodes, and a charging unit disposed in the support body, electrically connected to the charging electrodes and connected to an external power.

The charging dock may further include a reflecting bowl formed on the top of the support body in a bowl form and formed to be depressed and face the speaker.

The body may further include a perfume emission unit removably mounted at a location facing the sound output unit and configured to emit various perfumes.

The perfume emission unit may include a perfume emission container combined with a seating cavity formed in the body and configured to form an inner space, a perfume emission element contained in the perfume emission container so that it can be replaced, and configured to emit a perfume while subliming, and a cover removably attached to a top of the perfume emission container, configured to close the perfume emission container, and provided with a plurality of through emission slits.

The power supply unit of the body may be supplied with power by separating the data storage unit from the body and being connected to an external power through a power cable.

The program engine may be subjected to firmware upgrading or networking by separating the data storage unit from the body and being connected to a computer network through connection means.

The connection means may be any one of a USB cable, an RFID unit, an infrared wireless communication unit, and an S-ATA cable.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the overall configuration of a multifunctional therapeutic device with educational and entertainment functions according to an embodiment of the present invention;

FIG. 2 is a perspective view showing the overall configuration of the multifunctional therapeutic device with educational and entertainment functions according to the embodiment of the present invention;

FIGS. 3 and 4 are views seen in directions A and B of FIG. 2; and

FIGS. 5 to 7 are conceptual diagrams and a block diagram showing the conventional technology.

### DETAILED DESCRIPTION OF THE INVENTION

Reference now should be made to the drawings, in which the same reference numerals are used throughout the different drawings to designate the same or similar components.

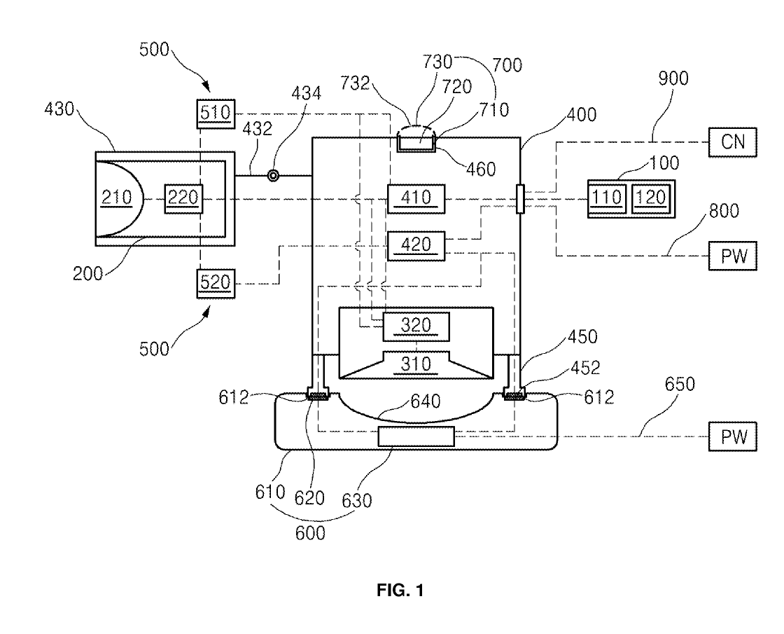

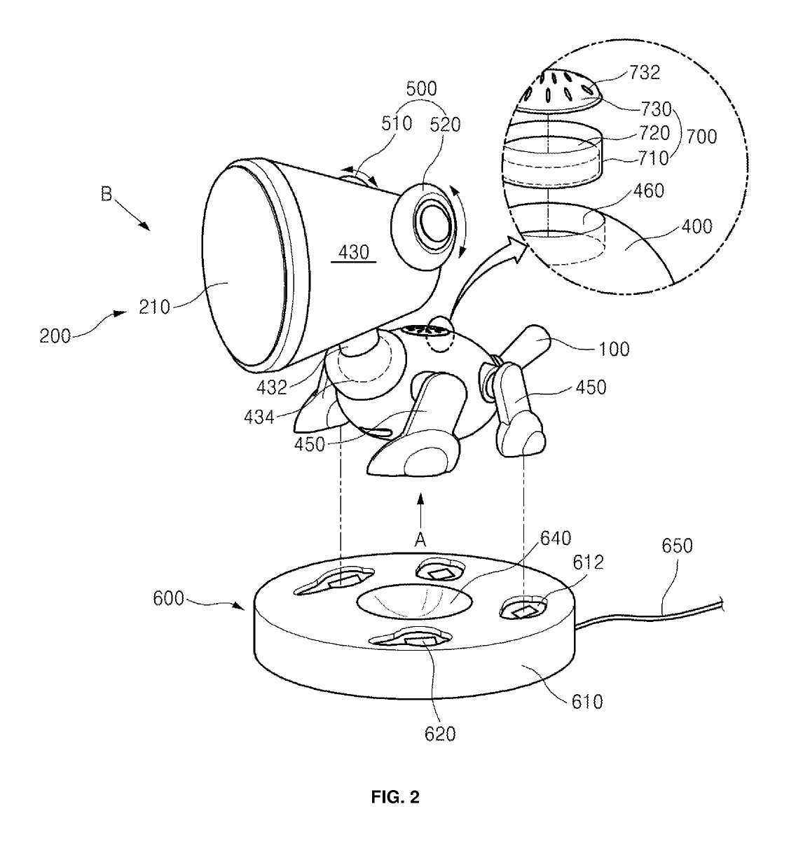

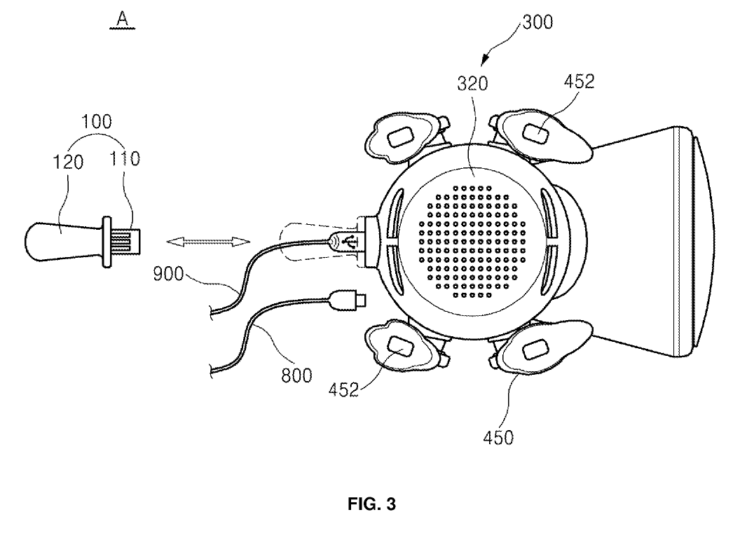

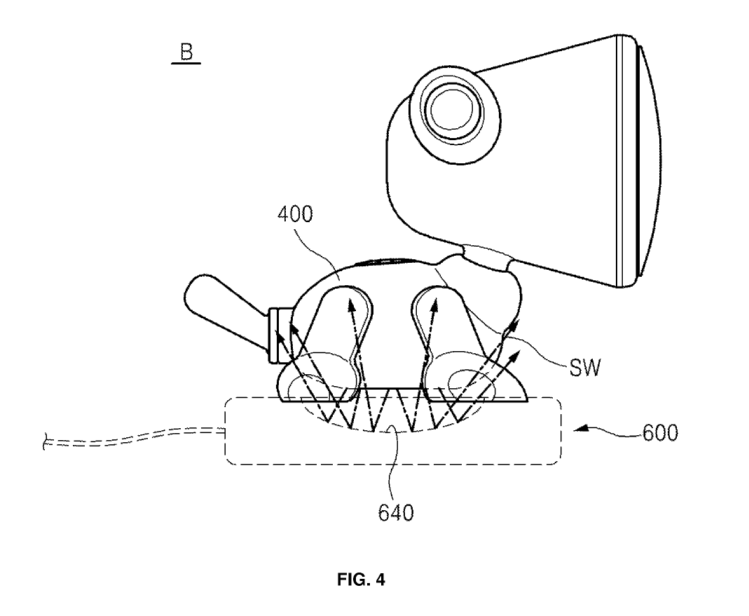

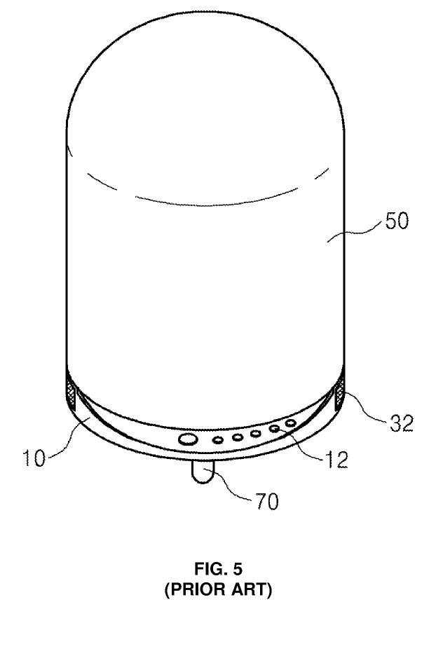

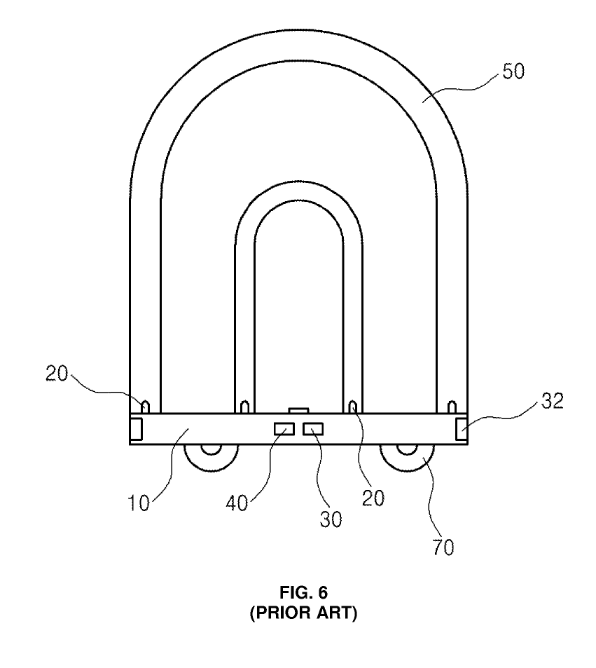

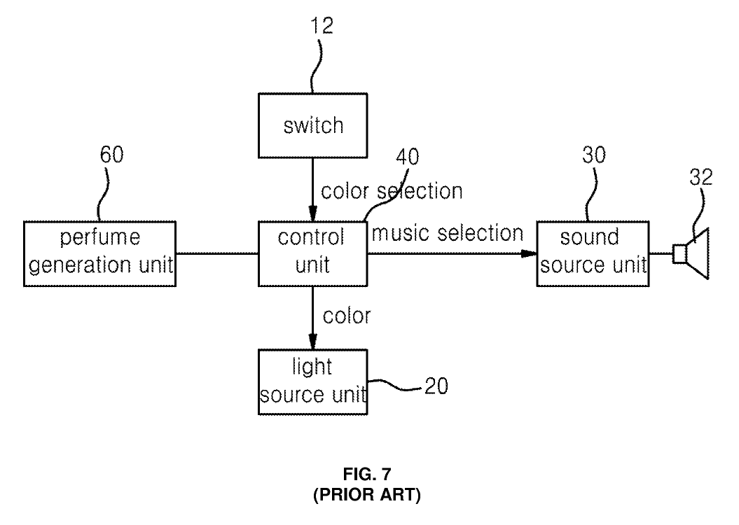

FIG. 1 is a block diagram showing the overall configuration of a multifunctional therapeutic device with educational and entertainment functions according to an embodiment of the present invention, FIG. 2 is a perspective view showing the overall configuration of the multifunctional therapeutic device with educational and entertainment functions according to the embodiment of the present invention, and FIGS. 3 and 4 are views seen in directions A and B of FIG. 2.

As shown in the above drawings, the multifunctional therapeutic device according to the present invention includes a data storage unit 100, an image display unit 200, and a sound output unit 300.

Here, the body 400 includes a program engine 410 for outputting an image including a number, a character, a diagram and/or variously colored light and issuing sounds including voices and the other types of sound and a power supply unit 420 for supplying driving power. It will be apparent that the body 400 is not limited to any particular shape or appearance.

Here, although the program engine 410 is not shown in detail in the drawings, it includes a Central Processing Unit (CPU) and a data processing unit for processing input data, and is configured in the form of a driving operating system which outputs an image and a sound using the image display unit 200 and the sound output unit 300. Since the process of outputting an image and sound corresponds to a technology well known to those skilled in the art, a detailed description thereof may be omitted here.

First, the data storage unit 100 according to the present invention is provided on one side of the body 400, functions to temporarily store image and sound output data downloaded from the outside, and is electrically connected to the program engine 410.

The image display unit 200 according to the present invention is provided on the remaining side of the body 400, and functions to output an image based on data, input to the data storage unit 100, through the program engine 410.

The sound output unit 300 according to the present invention is provided between the data storage unit 100 and the image display unit 200, and functions to output sounds based on the sound output data of the data storage unit 100 through the program engine 410.

Accordingly, the multifunctional therapeutic device with educational and entertainment functions according to the present invention enables the image display unit 200 and the sound output unit 300 to operate independently or in combination.

The present invention is practiced based on the above-described configuration. In order to instigate interest and increase educational performance, the multifunctional therapeutic device may assume an animal or character shape, as shown in FIGS. 2 to 4. This embodiment will be described in detail below with reference to the drawings.

The data storage unit 100 according to the present invention is removably mounted on one side of the body 400, is electrically connected to the program engine 410, functions to temporarily store image and sound output data downloaded from the outside, and includes a fastening element 110 and a storage body 120.

The fastening element 110 is electrically connected to an external device (not shown) or the program engine 410, functions to receive data from the external device and to electrically connect image and sound output data to the program engine 410, and may employ a USB method, an RFID method, an infrared wireless communication method or an S-ATA method.

The storage body 120 is electrically connected to the fastening element 110, functions to provide a space for temporarily storing image and sound output data downloaded from the external device, and may be formed of flash memory, such as USB memory, an SD, XD or CF card, or a hard disk.

Here, the fastening element 110 and the storage body 120 are not limited to the above-described connection methods or storage methods, but may be practiced using appropriate connection and storage methods based on a variety of types of technology.

The data storage unit 100 is separated from the body 400, as shown in FIG. 3, and the body 400 is connected to an external power source PW through a power cable 800 and is then supplied with power.

Here, although not shown in the drawings, a lamp for displaying current power status, that is, a battery level and battery charging status, may be installed on the body 400.

Furthermore, the data storage unit 100 is separated from the body 400, as shown in FIG. 3, a computer network CN and the program engine 410 are connected to each other by connection means 900, thereby being able to perform firmware upgrading or networking.

The connection means 900 may perform interconnection using any one of various means, including a USB cable, an RFID unit, an infrared wireless communication unit and an S-ATA cable.

Accordingly, by using the connection means 900, a user can periodically upgrade a new driving program engine 410, and can perform clinical therapy using networking.

That is, a user can use a service, such as making a diagnosis or prescription regarding the current physical status, by transferring data, such as selected sounds and images, to a clinical therapy institution using networking.

Meanwhile, the image display unit 200 according to the present invention is mounted on the remaining side of the body 400 so that the angle thereof can be adjusted in all directions, is electrically connected to the program engine 410, outputs an image based on the image output data of the data storage unit 100 through the program engine 410, and includes a display panel 210 and an image encoder 220.

Here, the display panel 210 outputs an image based on image output data, and may be implemented using any one of various means, such as RGB LEDs, an LCD and a PDP.

In this case, the image encoder 220 electrically connects the display panel 210 and the program engine 410 to each other, and functions to convert information for the driving of the program engine 410 into an image signal.

Furthermore, the image display unit 200 is preferably mounted on an end of a head part 430 which is rotatably combined with the body 400. In order to enable the adjustment of an angle in all directions, it is preferred that a neck 432 protrude from the bottom of the head part 430 and a spherical joint 434 be further provided on an end of the neck 432 to allow the neck 432 to rotate with respect to the body 400.

A conductor (not shown) may be provided on the portion of the body 400 in contact with the spherical joint 434 to make an electrical connection with the spherical joint 434.

Accordingly, a user may use the image display unit 200 of the present invention as an illumination device using variously colored light output from the display panel 210, and may also enjoy various types of image output, such as a number, a character and a diagram, together with sound output from the sound output unit 300 (which will be described in detail later).

Next, the sound output unit 300 according to the present invention is installed between the data storage unit 100 and the image display unit 200, is electrically connected to the program engine 410, functions to output a sound based on the sound output data of the data storage unit 410 through the program engine 410, and includes a speaker 310 (refer to FIG. 3) and a sound encoder 320.

The speaker 310 is mounted on the body 410, and functions to output sound. The sound encoder 320 electrically connects the speaker 310 and the program engine 410 to each other, and functions to convert information for the driving of the program engine 410 into a sound signal.

Here, for ease of convenience, detailed descriptions of the structures and operations of the sound encoder 320 and the image encoder 210 will be omitted here.

Accordingly, a user may use the multifunctional therapeutic device for language learning by synchronizing the image output through the display panel 210 with the sound output through the speaker 310 as described above.

For example, language learning using the visual and auditory senses may be performed by causing the speaker 310 to output a pronunciation corresponding to a specific character and causing the display panel 210 to display the specific character.

Meanwhile, it is preferred that an adjustment and selection unit 500, which is capable of both adjusting the brightness of an image output from the image display unit 200 and the pitch of a sound output from the sound output unit 300 and of selecting the type of program engine 410 of the body 400 including the power supply unit 420, be provided on both sides of the body between the data storage unit 100 and the image display unit 200 and be electrically connected to the program engine 410.

In detail, the adjustment and selection unit 500 is configured to include an adjustment switch 510 and a selection switch 520 which are rotatably mounted on both sides of the body between the data storage unit 100 and the image display unit 200.

That is, the adjustment switch 510 is rotatably mounted on one side between the data storage unit 100 and the image display unit 200, and functions to adjust the brightness of an image output from the image display unit 200 and the pitch of a sound output from the sound output unit 300.

Furthermore, the selection switch 520 is rotatably mounted on the remaining side between the data storage unit 100 and the image display unit 200, and functions to select the type of program engine 410 of the body 400 including the power supply unit 420 and to selectively turn on and off power.

Accordingly, a user may turn on or off power by manipulating the selection switch 520, cause an image and a sound to be separately or simultaneously output by turning the selection switch 520 in either direction, and appropriately adjust the brightness of an image and the pitch of a sound by rotating the adjustment switch 510 in either direction.

Here, the adjustment switch 510 and the selection switch 520 may be manipulated using any one of various methods, such as rotational manipulation and pressing manipulation.

That is, the adjustment switch 510 adjusts the brightness of an image or the pitch of a sound by rotational manipulation, and may fix a current state by pressing manipulation. Meanwhile, the selection switch 520 selects image output or sound output by rotational manipulation, and may perform the image output and the sound output separately or simultaneously by performing one or more pressing operations after making the selection.

The adjustment and selection unit 500 configured as described above may be modified or varied, as in an example in which the adjustment switch 510 and the selection switch 520 are respectively mounted on both sides of the head part 430, as shown in FIGS. 2 to 4.

Furthermore, it will be apparent that the adjustment and selection unit 500 may be modified or varied in such a way that illumination devices, which are capable of varying and emitting variously colored light in response to being selected or adjusted by rotational manipulation, are respectively disposed inside the adjustment switch 510 and the selection switch 520 which are configured as described above.

Meanwhile, the body 400 is further provided with a plurality of support legs 450 which are mounted on the outside of the body 400, support the body 400, and are electrically connected to the power supply unit 420. In this case, it is preferred that the speaker 310 be mounted on the lower side of body 400.

Here, the support legs 450 function to charge the multifunctional therapeutic device with power using separate means while supporting the body 400.

For this purpose, the ends of the support leg 450 are provided with electrodes 452 which are electrically connected to the power supply unit 420 of the body 400, as shown in FIG. 3. Means for charging the multifunctional therapeutic device with power may be a charging dock 600 which is brought into contact with the support legs 450. The charging dock 600 includes a support body 610, a charging electrode 620, and a charging unit 630.

The charging dock 600 functions to charge and supply power while stably supporting the multifunctional therapeutic device with educational and entertainment functions according to the present invention.

The support body 610 is provided with support depressions 612 in which the support legs 450 are respectively disposed, faces the speaker 310, and is configured in the form of a plate. The charging electrodes 620 are respectively disposed in the support depressions 612, and come into contact with and are electrically connected to the electrodes 452. The charging unit 630 is installed inside the support body 610, is electrically connected to the charging electrode 620, and is connected to an external power PW through a charging cable 650.

Accordingly, a user may separate the data storage unit 100 from the body 400 and perform charging or supply power through the power cable 800, as described above. Alternatively, a user may perform charging or power supply using the charging dock 600.

That is, when the power level is low during the output of an image and/or a sound based on the data of the data storage unit 100, a user can perform output of the image and/or sound and charging at the same time by placing the support legs 450 of the body 400 on the charging dock 600, maintaining electrical contact, and then performing charging.

Furthermore, although not shown in the drawings, a lamp for displaying current power status, that is, a battery level and battery charging status, may be installed in the charging dock 600.

Meanwhile, the charging dock 600 is further provided with a reflecting bowl 640 which is formed in the top surface of the support body 610 in the form of a bowl to face the speaker 310, as shown in FIG. 4, thereby implementing a sound effect in which a sound SW output from the speaker 310 is reflected by the reflecting bowl 640, travels along the curved surface of the body 400 and propagates smoothly.

Here, the charging dock 600 may be provided with illumination devices which are disposed around the reflecting bowl 640 or the speaker 310 depending on need or preference, thereby implementing various visual effects in which light, the color of which changes depending on the output of the sound SW, is emitted.

Meanwhile, it is preferred that the body 400 be provided with a perfume emission unit 700 which is removably disposed at a location facing the speaker 310 of the sound output unit 300 and, in detail, on the top of the body 400, and which emits various perfumes. The perfume emission unit 700 (refer to the enlarged portion of FIG. 2) includes a perfume emission container 710, a perfume emission element 720, and a cover 730.

Here, the perfume emission container 710 is fitted into a seating cavity 460 formed in the body 400, forms an inner space, and is configured in the form of a circular container. The perfume emission element 720 is contained in the perfume emission container 710 so that it can be replaced, and emits a perfume while subliming. The cover 730 is detachably combined with the top of the perfume emission container 710, and closes the perfume emission container 710. A plurality of emission slits 732 are formed through the cover 730.

The perfume emission unit 700 may use the solid-type perfume emission element 720, as described above. Alternatively, although not shown in the drawings, the perfume emission unit 700 may be modified or varied, as in an example in which a liquid-type perfume emission element is disposed in a container and is then used to fumigate. For this purpose, it may be possible to additionally install a heater or fumigator on the body 400.

Accordingly, a user causes an image and a sound to be output through the image display unit 200 and the sound output unit 300 and, at the same time, selects a perfume suitable for an atmosphere and a physical condition and causes the selected perfume to be emitted through the perfume emission unit 700, thereby achieving the stabilization of body and mind based on the visual, auditory and olfactory senses.

The operation of the multifunctional therapeutic device with educational and entertainment functions according to the present invention will be described briefly with reference to FIGS. 1 to 4.

First, a user separates the data storage unit 100 from the body 400, downloads image and sound output data from an external device to the data storage unit 100, combines the data storage unit 100 with the body 400 again, and turns on power by manipulating the selection switch 520 provided on both sides of the head part 430.

Thereafter, the user selects the driving programs of the program engine 410 installed in the body 400, that is, sound and image output programs, selectively or in combination by performing the rotational or pressing manipulation of the selection switch 520, and adjusts an output image and sound by performing the rotational or pressing manipulation of the adjustment switch 510.

At the same time, the user selects an appropriate perfume and installs the perfume emission unit 700 in the top of the body 400, thereby causing the perfume to be emitted.

Meanwhile, when the power level is low, the user places the support legs 450 of the body 400 on the additionally provided charging dock 600, thereby causing the multifunctional therapeutic device to be supplied with power through the electrodes 452 provided on the ends of the support legs 450.

Thereafter, the user completes the operation by turning off power by manipulating the selection switch 520.

From the above description, it can be seen that the basic technical spirit of the present invention is to provide a multifunctional therapeutic device with educational and entertainment functions, which is capable of promoting consumers' desire to possess it, improving educational performance and cultivating feelings by stimulating interest, and providing psychological therapy by putting the body and mind at ease.

Meanwhile, it will be apparent to those skilled in the art that the multifunctional therapeutic device with educational and entertainment functions according to the present invention may be variously modified or varied within the range of the basic technical spirit of the present invention, as in an example in which the multifunctional therapeutic device is used as an educational or entertainment toy or a clinical therapeutic device.

According to the present invention configured as described above, the following advantages can be achieved.

First, the present invention adopts a configuration including a data storage unit removably mounted on one side of a body, an image display unit mounted on the remaining side of the body so that the angle thereof can be adjusted in all directions, and a sound output unit mounted between the data storage unit and the image display unit, so that the multifunctional therapeutic device can be configured in any one of various character shapes, thereby promoting consumers' desire to possess it.

Furthermore, the present invention can improve the educational performance of the young age groups by stimulating the interest by operating the image display unit and the sound output unit separately or in combination, and can provide physiological therapy to the middle and old age groups by cultivating feelings and putting the body and mind at ease by adding a perfume emission unit to the body.

Moreover, the present invention is configured such that the data storage unit is separated from the body, the body is connected to the network cable, a tendency to select sounds based on various types of sounds stored in the program engine and output through the sound output unit and a tendency to select perfumes emitted through the perfume emission unit are detected, and then the detected tendencies are used for active clinical therapy.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A multifunctional therapeutic device with educational and entertainment functions, including a body including a program engine for outputting an image and a sound and a power supply unit for supplying driving power, the multifunctional therapeutic device comprising:
a data storage unit removably mounted on one side of the body, electrically connected to the program engine, and configured to temporarily store image and sound output data downloaded from an outside;
an image display unit mounted on a remaining side of the body so that an angle thereof can be adjusted in all directions, electrically connected to the program engine, and configured to output an image through the program engine based on image output data of the data storage unit; and
a sound output unit mounted between the data storage unit and the image display unit, electrically connected to the program engine, and configured to output a sound through the program engine based on sound output data of the data storage unit;
wherein the image display unit and the sound output unit are operated separately or in combination.

2. The multifunctional therapeutic device as set forth in claim 1, further comprising, on both sides of the body between the data storage unit and the image display unit, an adjustment and selection unit electrically connected to the program engine, and configured to adjust brightness of the image output from the image display unit and pitch of a sound output from the sound output unit and to select a type of program engine of the body including the power supply unit.

3. The multifunctional therapeutic device as set forth in claim 2, wherein the adjustment and selection unit comprises:
an adjustment switch rotatably mounted on one side of the body between the data storage unit and the image display unit, and configured to adjust brightness of the image output from the image display unit and the pitch of the sound output from the sound output unit; and
a selection switch rotatably mounted on a remaining side of the body between the data storage unit and the image display unit, and configured to select the type of program engine of the body including the power supply unit or selectively turn on and off power.

4. The multifunctional therapeutic device as set forth in claim 1, wherein:
the body further comprises a head part rotatably attached to the body including the power supply unit;
the image display unit is mounted on one end of the head part; and
the adjustment and selection unit is mounted on both sides of the head part.

5. The multifunctional therapeutic device as set forth in claim 4, wherein the head part further comprises a spherical joint provided on one end of a neck protruding downwards and rotatably combined with the body.

6. The multifunctional therapeutic device as set forth in claim 1, wherein the data storage unit comprises:
a fastening element electrically connected to an external device or the program engine of the body; and
a storage body electrically connected to the fastening element and configured to temporality store downloaded image and sound output data.

7. The multifunctional therapeutic device as set forth in claim 6, wherein the fastening element is connected to the body or external device using a USB method, an RFID method, an infrared wireless communication method or an S-ATA method.

8. The multifunctional therapeutic device as set forth in claim 6, wherein the storage body is formed of any one of USB memory, flash memory and a hard disk.

9. The multifunctional therapeutic device as set forth in claim 1, wherein the image display unit comprises:
a display panel for outputting an image; and
an image encoder for electrically connecting the display panel and the program engine to each other and converting driving information of the program engine into an image signal.

10. The multifunctional therapeutic device as set forth in claim 9, wherein the display panel is formed of any one of RGB LEDs, an LCD and a PDP.

11. The multifunctional therapeutic device as set forth in claim 1, wherein the sound output unit comprises:
a speaker mounted on the body including the power supply unit and configured to output a sound; and
a sound encoder for electrically connecting the speaker and the program engine to each other, and configured to convert driving information of the program engine into a sound signal.

12. The multifunctional therapeutic device as set forth in claim 11, wherein:
the body further comprises a plurality of support legs mounted on an outside of the body, configured to support the body, and electrically connected to the power supply unit; and
the speaker is mounted on a bottom of the body.

13. The multifunctional therapeutic device as set forth in claim 12, wherein the support legs are provided with electrodes provided at ends of the support legs and electrically connected to the power supply unit of the body on which the speaker is mounted.

14. The multifunctional therapeutic device as set forth in claim 13, wherein the body further comprises a charging dock, including a support body provided with support depressions in which the support legs are placed and disposed to face the speaker, charging electrodes disposed in the support depressions and configured to come into contact with the electrodes, and a charging unit disposed in the support body, electrically connected to the charging electrodes and connected to an external power.

15. The multifunctional therapeutic device as set forth in claim 14, wherein the charging dock further comprises a reflecting bowl formed on a top of the support body in a bowl form and formed to be depressed and face the speaker.

16. The multifunctional therapeutic device as set forth in claim 1, wherein the body further comprises a perfume emission unit removably mounted at a location facing the sound output unit and configured to emit various perfumes.

17. The multifunctional therapeutic device as set forth in claim 16, wherein the perfume emission unit comprises:
a perfume emission container combined with a seating cavity formed in the body and configured to form an inner space;
a perfume emission element contained in the perfume emission container so that it can be replaced, and configured to emit a perfume while subliming; and
a cover removably attached to a top of the perfume emission container, configured to close the perfume emission container, and provided with a plurality of through emission slits.

18. The multifunctional therapeutic device as set forth in claim 1, wherein the power supply unit of the body is supplied with power by separating the data storage unit from the body and being connected to an external power through a power cable.

19. The multifunctional therapeutic device as set forth in claim 1, wherein the program engine is subjected to firmware upgrading or networking by separating the data storage unit from the body and being connected to a computer network through connection means.

20. The multifunctional therapeutic device as set forth in claim 19, wherein the connection means is any one of a USB cable, an RFID unit, an infrared wireless communication unit, and an S-ATA cable.
